(19) United States
(12) Patent Application Publication
(10) Pub. No.: US 2009/0220823 A1
(43) Pub. Date: Sep. 3, 2009

(54) FERROMAGNETIC METAL PARTICLES AND PROCESS FOR PRODUCING THE SAME, AND MAGNETIC RECORDING MEDIUM

(75) Inventors: Hiroko MORII, Otake-shi (JP); Seiji Ishitani, Otake-shi (JP); Keisuke Iwasaki, Otake-shi (JP); Hirofumi Nishikawa, Otake-shi (JP); Mineko Ohsugi, Otake-shi (JP); Toshiharu Harada, Sanyo Onoda-shi (JP); Takahiro Matsuo, Sanyo Onoda-shi (JP); Yosuke Yamamoto, Sanyo Onoda-shi (JP); Kazuyuki Hayashi, Otake-shi (JP)

Correspondence Address: NIXON & VANDERHYE, PC, 901 NORTH GLEBE ROAD, 11TH FLOOR, ARLINGTON, VA, 22203, US

(73) Assignee: TODA KOGYO CORPORATION, Otake-shi (JP)

(21) Appl. No.: 12/394,473

(22) Filed: Feb. 27, 2009

(30) Foreign Application Priority Data
Feb. 29, 2008 (JP) 2008-050705

(51) Int. Cl. G11B 5/706; H01F 1/01; B32B 5/16

(52) U.S. Cl. 428/846; 252/62.56; 252/62.57; 252/62.58; 428/402

(57) ABSTRACT

The present invention relates to ferromagnetic metal particles having a bulk density (ρa) of not more than 0.25 g/cm³, a process for producing the above ferromagnetic metal particles and a magnetic recording medium comprising a non-magnetic substrate; a non-magnetic undercoat layer formed on the non-magnetic substrate which comprises non-magnetic particles and a binder resin; and a magnetic recording layer formed on the non-magnetic undercoat layer which comprises magnetic particles and a binder resin, wherein the above ferromagnetic metal particles were used as the magnetic particles.

### BACKGROUND OF THE INVENTION

The present invention relates to ferromagnetic metal particles that are improved in dispersibility without deterioration of fluidity, a process for producing the ferromagnetic metal particles, and a magnetic recording medium using the ferromagnetic metal particles which exhibits a good surface smoothness.

Magnetic recording techniques have been extensively used not only in audio, video and computer applications but also various other applications. In recent years, there is an increasing demand for miniaturization, weight reduction and recording-time prolongation of magnetic recording apparatuses as well as increase in recording capacity thereof. With such a recent demand, it has been required to provide magnetic recording media having a still higher recording density.

In order to perform high-density recording on conventional magnetic recording media, it is required that the magnetic recording media has a high C/N ratio, i.e., a low noise (N) and a high reproduction output (C). In recent years, high-sensitive heads such as a magneto-resistance type head (MR head) and a giant magneto-resistance type head (GMR head) have been developed instead of conventional induction-type magnetic heads. These magneto-resistance type heads are apt to produce a high reproduction output as compared to the conventional induction-type magnetic heads. Therefore, in order to attain a high C/N ratio, it becomes more important to reduce the noise rather than to increase the output.

The noise of the magnetic recording media is generally classified into particle noise and surface noise that is generated owing to a surface property of the magnetic recording media. The particle noise is largely influenced by a particle size of magnetic particles, and can be advantageously reduced as the particle size becomes smaller. Therefore, it is required that the particle size of the magnetic particles used in the magnetic recording media is as small as possible.

On the other hand, in order to reduce the surface noise, it is important to improve a surface smoothness of the magnetic recording media. For this purpose, it is inevitably required to improve dispersibility of the magnetic particles in a magnetic coating material or orientation and filling property of the magnetic particles in a magnetic recording layer.

In general, finer particles are more difficult to handle and, therefore, must be improved in characteristics such as fluidity. The Hausner ratio (tap density/bulk density) is known as an index indicating a fluidity of particles. The closer to 1 the ratio, i.e., the smaller the difference between the tap density and bulk density, the more excellent the fluidity of the particles.

In consequence, conventionally, in order to design magnetic particles having a high filling rate in the magnetic recording layer and exhibiting an excellent fluidity, the magnetic particles have been subjected to compaction treatment, etc., to enhance both tap density and bulk density of the magnetic particles.

For the purpose of improving a fluidity of magnetic particles, there have been proposed the magnetic particles having a tap density and a compaction degree which are limited to specific ranges (Japanese Patent Application Laid-open (KOKAI) Nos. 2002-53903 and 3-276423 (1991)).

Also, for the purpose of improving a dispersibility of magnetic particles, there have been proposed the magnetic particles having a ratio of bulk density/true density which is limited to a specific range (Japanese Patent Application Laid-open (KOKAI) No. 62-95729 (1987)).

In addition, for the purpose of improving a filling property of magnetic particles, there have been proposed the magnetic particles having a tap density that is limited to a specific range (Japanese Patent Application Laid-open (KOKAI) Nos. 2007-81227 and 2004-335744).

At present, it has been strongly required to provide ferromagnetic metal particles which allow a magnetic recoding layer to exhibit a high surface smoothening effect when subjected to calendar treatment, are excellent in filling property in the magnetic recording layer, and are improved in dispersibility without deterioration of fluidity, as well as a process for producing the ferromagnetic metal particles. However, the ferromagnetic metal particles and the production process have not been attained until now.

More specifically, in the techniques described in Japanese Patent Application Laid-open (KOKAI) Nos. 2002-53903 and 3-276423 (1991), the bulk density, tap density and compaction degree of the ferromagnetic particles are limited to the respective specific ranges. However, since both the techniques aim at improving a fluidity of the ferromagnetic particles, the bulk density of the ferromagnetic particles is as high as not less than 0.35 g/cm³. As a result, a kneading torque tends to be hardly applied to the particles because of poor dispersion upon production of a magnetic coating material, so that it may be difficult to obtain a magnetic recording medium having an excellent surface smoothness.

Also, in the technique described in Japanese Patent Application Laid-open (KOKAI) No. 62-95729 (1987), the ratio of bulk density/true density of the fine ferromagnetic metal particles is limited to the range of 0.07 to 0.16. However, the particles must be subjected to compaction treatment in order to adjust the ratio of bulk density/true density thereof to the above specified range, so that the bulk density of the resulting fine ferromagnetic metal particles tends to become large. As a result, a kneading torque tends to be hardly applied to the particles because of poor dispersion upon production of a magnetic coating material, thereby failing to obtain a magnetic recording medium having an excellent surface smoothness.

In addition, in the techniques described in Japanese Patent Application Laid-open (KOKAI) Nos. 2007-81227 and 2004-335744, the tap density of the ferromagnetic particles is limited to the specific range. However, the tap density is as high as not less than 0.41 g/cm³ as described in Examples, and the bulk density of the ferromagnetic particles are not taken into consideration.

### SUMMARY OF THE INVENTION

An object of the present invention is to provide ferromagnetic metal particles which allow a magnetic recording layer to exhibit a high surface smoothening effect when subjected to calendar treatment, are excellent in filling property in the magnetic recording layer, and are improved in dispersibility without deterioration of fluidity, as well as a process for producing the ferromagnetic metal particles.

As a result of the present inventors' earnest study for solving the above conventional problems, it has been found that the ferromagnetic metal particles having a bulk density of not more than 0.25 g/cm³ are bulky and readily applied with a kneading torque upon production of a magnetic coating material owing to less aggregation between the particles, and exhibit an excellent dispersibility and a high filling rate in a magnetic recording layer, thereby providing a magnetic recording medium having an excellent surface property; and that the ferromagnetic metal particles in which a ratio between a volume-average diameter under a dispersing pressure of 3 bar ((D50)_{3bar}) and a volume-average diameter under a dispersing pressure of 5 bar ((D50)_{5bar}) is close to 1, are readily deaggregated even when applying a very small dispersing force thereto and, therefore, exhibit an excellent dispersibility, and further are improved in dispersibility without deterioration of fluidity when the particles are designed to have a tap density of not more than 0.39 g/cm³ which is lower than that of the conventional ferromagnetic metal particles. The present invention has been attained based on the above finding.

That is, in a first invention, there is provided a ferromagnetic metal particles having a bulk density (pa) of not more than 0.25 g/cm³ (Invention 1).

In a second invention, there is provided a Ferromagnetic metal particles according to Invention 1, which have a tap density (ρt) of not more than 0.39 g/cm³ (Invention 2).

In a third invention, there is provided ferromagnetic metal particles according to Invention 2, which have a Hausner ratio of the tap density (ρt) to the bulk density (ρa) (ρt/ρa) of not more than 1.80 (Invention 3).

In a fourth inventions there is provided ferromagnetic metal particles according to Invention 1, comprising Fe, Co, Al and rare earth element (Invention 4).

In a fifth invention, there is provided ferromagnetic metal particles according to Invention 1, which have a coercive force Hc of 79.6 to 278.5 kA/m (Invention 5).

In a sixth invention, there is provided ferromagnetic metal particles according to Invention 1, which have a saturation magnetization (σs) of 50 to 180 Am²/kg (Invention 6).

In a seventh invention, there is provided ferromagnetic metal particles according to Invention 1, which have a ratio of a volume-average diameter (D50)_{3bar} under a dispersing pressure of 3 bar to a volume-average diameter (D50)_{5bar} under a dispersing pressure of 5 bar ((D50)_{3bar}/(D50)_{5bar}) of not more than 1.2 (Invention 7).

In an eighth invention, there is provided a process for producing the ferromagnetic metal particles as defined in Invention 1, comprising the steps of:

subjecting a liquid-containing material comprising goethite particles and having a solid content of not more than 50% by weight to vacuum freeze drying;

subjecting the freeze-dried goethite particles to heat dehydration to obtain hematite particles; and

subjecting the hematite particles to heat reduction to obtain magnetic metal particles (Invention 8).

In a ninth invention, there is provided a magnetic recording medium comprising a non-magnetic substrate; a non-magnetic undercoat layer formed on the non-magnetic substrate which comprises non-magnetic particles and a binder resin; and a magnetic recording layer formed on the non-magnetic undercoat layer which comprises magnetic particles and a binder resin, wherein the ferromagnetic metal particles as defined in Invention 1 were used as the magnetic particles (Invention 9).

### DETAILED DESCRIPTION OF THE INVENTION

The present invention is described in detail below.

First, the ferromagnetic metal particles according to the present invention are described.

The ferromagnetic metal particles according to the present invention are basically obtained by subjecting goethite particles comprising Fe, Co, Al, rare earth element, etc., to vacuum freeze drying, if required, after coating the surface of the goethite particles with an anti-sintering agent; heat-treating the freeze-dried goethite particles to obtain hematite particles; and then subjecting the resulting hematite particles to heat reduction at a temperature of 300 to 700° C. Therefore, the finally obtained ferromagnetic metal particles also comprise Fe, Co, Al, rare earth element and oxides thereof.

The ferromagnetic metal particles according to the present invention preferably have an average primary major axis diameter of 5 to 250 nm. When the average primary major axis diameter is less than 5 nm, the resulting ferromagnetic metal particles tend to be rapidly deteriorated in oxidation stability, and simultaneously hardly exhibit a high coercive force and a good coercive force distribution SFD (switching field distribution). When the average primary major axis diameter is more than 250 nm, the resulting ferromagnetic metal particles tend to have a large particle size, so that a magnetic recoding medium produced by using the particles tends to be deteriorated in surface smoothness, and hardly improved in output characteristics owing to the poor surface smoothness.

In particular, from the viewpoint of high-density recording property as demanded recently, the average primary major axis diameter of the ferromagnetic metal particles is preferably 5 to 100 nm, more preferably 5 to 90 nm and still more preferably 5 to 80 nm. In this case, the ferromagnetic metal particles having an average primary major axis diameter of more than 100 nm tend to be not only deteriorated in saturation magnetization and coercive force in a short wavelength range, but also undesirably increased in particle noise.

The ferromagnetic metal particles according to the present invention are of an acicular shape and have an aspect ratio (ratio of average primary major axis diameter to average primary minor axis diameter; hereinafter referred to merely as an “aspect ratio”) of preferably not less than 2.0 and more preferably 2.5 to 8.0. When the aspect ratio is less than 2.0, it may be difficult to obtain ferromagnetic metal particles having a high coercive force as aimed. The “acicular shape” as used herein includes not only a literally acicular shape, but also a spindle shape and a rice grain-like shape.

The ferromagnetic metal particles according to the present invention preferably have a BET specific surface area of 35 to 200 m²/g, more preferably 40 to 180 m²/g and still more preferably 50 to 150 m²/g. When the BET specific surface area is less than 35 m²/g, sintering between the particles tends to be caused during the production process of the ferromagnetic metal particles, so that a magnetic recording medium produced by using the particles tends to be deteriorated in surface smoothness and hardly improved in output characteristics owing to the poor surface smoothness. When the BET specific surface area is more than 200 m²/g, the ferromagnetic metal particles tend to have an excessively large surface area and, therefore, tend to be hardly wetted with a binder used in a magnetic coating material, so that the resulting magnetic coating material tends to exhibit a large viscosity and tends to be undesirably agglomerated together without being well dispersed.

The ferromagnetic metal particles according to the present invention have a bulk density (pa) of not more than 0.25 g/cm³, preferably not more than 0.24 g/cm³ and more preferably not more than 0.23 g/cm³. When the bulk density is more than 0.25 g/cm³, strong aggregation between the particles tends to be caused, so that a kneading torque tends to be hardly applied to the particles upon production of a magnetic coating material, resulting in poor dispersibility of the particles in the magnetic coating material and thereby failing to attain a high filling rate of the particles in a magnetic recording layer. From the viewpoint of good handling property of the ferromagnetic metal particles, the lower limit of the bulk density (ρa) thereof is 0.10 g/cm³.

The ferromagnetic metal particles according to the present invention have a tap density (ρt) of not more than 0.39 g/cm³, preferably not more than 0.38 g/cm³ and more preferably not more than 0.37 g/cm³. When the tap density is more than 0.39 g/cm³, the ferromagnetic metal particles having a low bulk density (ρa) as aimed by the present invention, tend to be deteriorated in fluidity. The lower limit of the tap density (ρt) of the ferromagnetic metal particles is 0.1 g/cm³.

The ferromagnetic metal particles according to the present invention have a Hausner ratio (tap density/bulk density) of preferably not more than 1.80, more preferably not more than 1.73 and still more preferably not more than 1.65. When the Hausner ratio is more than 1.80, the ferromagnetic metal particles tend to be deteriorated in fluidity, thereby failing to attain sufficient dispersibility and good handling property in a magnetic coating material. The lower limit of the Hausner ratio is 1, and the close to 1 the Hausner ratio, i.e., the smaller the difference between the tap density and bulk density, the more excellent the fluidity of the particles.

The ferromagnetic metal particles according to the present invention, when compressed under a pressure of 7.056 MPa, have a compressed density (CD) of preferably 0.5 to 3.0 g/cm³, more preferably 0.75 to 2.75 g/cm³ and still more preferably 1.0 to 2.5 g/cm³. When the compressed density (CD) of the ferromagnetic metal particles is less than 0.5 g/cm³, a magnetic recording medium produced by using the particles tends to hardly exhibit a good surface smoothening effect when subjected to calendar treatment, and the filling rate of the particles in a magnetic recording layer tends to be hardly increased, so that it may be difficult to improve a surface smoothness of the magnetic recording medium and enhance a recording density thereof.

The ferromagnetic metal particles according to the present invention have a ratio of bulk density (ρa)/compressed density (CD) of preferably not more than 0.50, more preferably not more than 0.32 and still more preferably not more than 0.23. When the ratio of bulk density (ρa)/compressed density (CD) is more than 0.50, a magnetic recording medium produced by using the particles tends to hardly exhibit a good surface smoothening effect when subjected to calendar treatment, and the filling rate of the particles in a magnetic recording layer tends to be hardly increased, so that it may be difficult to improve a surface smoothness of the magnetic recording medium and enhance a recording density thereof.

The ratio of a volume-average diameter under a dispersing pressure of 3 bar ((D50)_{3bar}) to a volume-average diameter under a dispersing pressure of 5 bar ((D50)_{5bar}) of the ferromagnetic metal particles according to the present invention (hereinafter referred to merely as the “ratio of (D50)_{3bar}/(D50)_{5bar}”) is not more than 1.30, preferably not more than 1.25 and more preferably not more than 1.20. As the ratio of (D50)_{3bar}/(D50)_{5bar} becomes closer to 1, the volume-average diameter under a dispersing pressure of 3 bar (D50)_{3bar} of the ferromagnetic metal particles becomes substantially identical to the volume-average diameter under a dispersing pressure of 5 bar (D50)_{5bar}, which means that the ferromagnetic metal particles can be readily disaggregated even when applying a weak dispersing force thereto. When the ratio of (D50)_{3bar}/(D50)_{5bar} is more than 1.30, strong agglomeration between the particles tends to be caused, so that it may be difficult to attain a good dispersibility of the particles upon production of a magnetic coating material.

The ferromagnetic metal particles according to the present invention have a cobalt content of preferably 4 to 50 atom %, more preferably 5 to 45 atom % and still more preferably 10 to 40 atom % in terms of Co based on whole Fe therein. When controlling the cobalt content in the ferromagnetic metal particles to the above specified range, it is possible to attain the below-mentioned magnetic properties (coercive force and saturation magnetization).

The ferromagnetic metal particles according to the present invention have an aluminum content of preferably 4 to 50 atom %, more preferably 5 to 45 atom % and still more preferably 10 to 40 atom % in terms of Al based on whole Fe therein. When the aluminum content in the ferromagnetic metal particles is less than 4 atom %, an anti-sintering effect upon the heat reduction step tends to be deteriorated, thereby causing undesirable deterioration in coercive force of the resulting particles. When the aluminum content in the ferromagnetic metal particles is more than 50 atom %, the resulting particles tend to be deteriorated in magnetic properties owing to increase in content of non-magnetic components therein, and the temperature required for the hydrogen reduction tends to be considerably increased, resulting in industrially disadvantageous process.

The ferromagnetic metal particles according to the present invention have a rare earth element content of preferably 2 to 30 atom %, more preferably 3 to 29 atom % and still more preferably 4 to 28 atom % in terms of rare earth element based on whole Fe therein. When the rare earth element content in the ferromagnetic metal particles is less than 2 atom %, an anti-sintering effect upon the heat reduction step tends to be deteriorated, thereby causing undesirable deterioration in coercive force of the resulting particles. When the rare earth element content in the ferromagnetic metal particles is more than 30 atom %, the resulting particles tend to be deteriorated in magnetic properties owing to increase in content of non-magnetic components therein, and the temperature required for the hydrogen reduction tends to be considerably increased, resulting in industrially disadvantageous process. Meanwhile, in the present invention, Sc and Y are also dealt with as the rare earth elements.

The ferromagnetic metal particles according to the present invention have a coercive force Hc of preferably 79.6 to 278.5 kA/m, more preferably 95.4 to 278.5 kA/m and still more preferably 119.4 to 278.5 kA/m. When the coercive force Hc of the ferromagnetic metal particles is out of the above specified range, it is not possible to obtain a high output in a short wavelength range, so that it may be difficult to enhance a recording density of the resulting magnetic recording medium.

The ferromagnetic metal particles according to the present invention have a saturation magnetization (σs) of preferably 50 to 180 Am²/kg, more preferably 60 to 170 Am²/kg and still more preferably 70 to 160 Am²/kg. When the saturation magnetization (σs) of the ferromagnetic metal particles is less than 50 AM²/kg, the resulting particles tend to be deteriorated in residual magnetization, thereby failing to obtain a high output in a short wavelength range. When the saturation magnetization (σs) of the ferromagnetic metal particles is more than 180 Am²/kg, the resulting particles tend to suffer from excessive residual magnetization, so that saturation of a magneto-resistance head as well as distortion of reproduction characteristics tend to be caused, thereby failing to obtain a high C/N ratio in a short wavelength range.

Next, the process for producing the ferromagnetic metal particles according to the present invention is described.

The ferromagnetic metal particles according to the present invention may be produced by subjecting a liquid-containing material comprising goethite particles as a starting material to vacuum freeze drying; heat-treating the freeze-dried goethite particles to obtain hematite particles; and then subjecting the resulting hematite particles to heat reduction at a temperature of 300 to 700° C.

The goethite particles used in the present invention may be obtained by a method of reacting a mixed alkali aqueous solution of an alkali hydroxide aqueous solution and an alkali hydrogen carbonate aqueous solution or alkali carbonate aqueous solution with a ferrous salt aqueous solution to obtain a water suspension comprising a ferrous-containing precipitate, and then passing an oxygen-containing gas through the water suspension to form the aimed goethite particles; or a method of reacting a mixed alkali aqueous solution of an alkali hydroxide aqueous solution and an alkali hydrogen carbonate aqueous solution or alkali carbonate aqueous solution with a ferrous salt aqueous solution to obtain a water suspension comprising a ferrous-containing precipitate, passing an oxygen-containing gas through the water suspension to form goethite seed crystal particles, and then growing a goethite layer on the surface of the respective goethite seed crystal particles. Further, the goethite particles may also be obtained by a method of reacting a mixed alkali aqueous solution of an alkali hydroxide aqueous solution and an alkali hydrogen carbonate aqueous solution or alkali carbonate aqueous solution with a ferrous salt aqueous solution to obtain a water suspension comprising a ferrous-containing precipitate, adding an oxidizing agent to the water suspension to obtain goethite seed crystal particles, and then growing a goethite layer on the surface of the respective goethite seed crystal particles. In the latter method, it is possible to obtain finer ferromagnetic metal particles.

Meanwhile, during the production reaction or growth reaction of the goethite particles, in order to suitably control various properties such as a particle shape, a particle size and magnetic properties, compounds comprising one or more elements selected from Co, Al and rare earth elements are preferably added to the reaction system.

Examples of the Co compound added include cobalt sulfate, cobalt chloride and cobalt nitrate. These Co compounds may be used singly or in the form of a mixture of any two or more thereof. The amount of the Co compound added is preferably 4 to 50 atom %, more preferably 5 to 45 atom % and still more preferably 10 to 40 atom % in terms of Co based on whole Fe in the goethite particles.

Examples of the Al compound added include aluminum salts such as aluminum sulfate, aluminum chloride and aluminum nitrate; and aluminates such as sodium aluminate, potassium aluminate and ammonium aluminate. These Al compounds may be used singly or in the form of a mixture of any two or more thereof. The amount of the Al compound added is preferably 4 to 50 atom %, more preferably 5 to 45 atom % and still more preferably 10 to 40 atom % in terms of Al based on whole Fe in the goethite particles.

Examples of the suitable rare earth element compound added include one or more compounds of scandium, yttrium, lanthanum, cerium, praseodymium, neodymium and samarium. Examples of the rare earth element compound include sulfates, chlorides, nitrates, etc., of the above rare earth elements. The amount of the rare earth element compound added is preferably 2 to 30 atom %, more preferably 3 to 29 atom % and still more preferably 4 to 28 atom % in terms of rare earth element based on whole Fe in the goethite particles.

Meanwhile, for the purposes of enhancing magnetic properties of the resulting particles and improving dispersibility of the particles in a magnetic coating material, other elements than those described above, for example, Si, Mg, Zn, Cu, Ti, Ni, P, etc., may be added thereto.

In the present invention, before being subjected to vacuum freeze drying, the surface of the respective goethite particles is preferably previously coated with an anti-sintering agent. The coating treatment with the anti-sintering agent may be conducted by ordinary methods. More specifically, the anti-sintering agent is added to and uniformly mixed with the water suspension comprising the goethite particles, and then the pH of the resultant mixture is adequately adjusted to allow the surface of the respective goethite particles to be coated with the anti-sintering agent. Thereafter, the thus treated goethite particles may be subjected to filtration and washing with water, and then to vacuum freeze drying.

Examples of the anti-sintering agent include, in addition to the above compounds comprising Co, Al and rare earth elements, phosphorus compounds such as sodium hexametaphosphate, polyphosphoric acid and orthophosphoric acid; silicon compounds such as water glass #3, sodium orthosilicate, sodium metasilicate and colloidal silica; boron compounds such as boric acid; aluminum compounds such as alumina sol and aluminum hydroxide; and titanium compounds such as titanium oxysulfate. These anti-sintering agents may be used singly or in combination of any two or more thereof. From the viewpoints of good anti-sintering effect and good magnetic properties of the resulting ferromagnetic metal particles, among these anti-sintering agents, preferred are compounds comprising Co, Al and rare earth elements.

The coating amounts of Co, Al and rare earth elements as the anti-sintering agent may respectively lie within the ranges as defined above in terms of atom % of each element based on whole Fe in the goethite particles. The coating amounts of the other elements are respectively preferably 0.1 to 40 atom %, more preferably 0.2 to 30 atom % and still more preferably 0.3 to 20 atom % in terms of each element based on whole Fe in the goethite particles.

In the present invention, the concentration of the liquid-containing material comprising the goethite particles before subjected to vacuum freeze drying (in terms of solid content) is preferably controlled to 5 to 50% by weight. When the concentration of the liquid-containing material is more than 50% by weight, the particles obtained after the vacuum freeze drying tend to be undesirably aggregated together. Also, when the solid content in the liquid-containing material is too low, the time required for the vacuum freeze drying tends to be prolonged, and the yield of the aimed product tends to be lowered, resulting in industrially disadvantageous process.

The solid content in the liquid-containing material is calculated as follow. The liquid-containing material comprising the goethite particles is weighed in an amount of 100 g, and then dried at not lower than a temperature capable of evaporating liquid constituting the liquid-containing material for 24 hr using a dryer to vaporize the liquid therefrom, and then the weight of the obtained dried product is measured to calculate the solid content from a weight ratio between the liquid-containing material and the dried product.

As the liquid constituting the liquid-containing material comprising the goethite particles before subjected to vacuum freeze drying, in addition to water, an organic solvent may also be used without any particular problems.

In the present invention, the vacuum freeze drying of the liquid-containing material comprising the goethite particles may be conducted by either a method of subjecting the liquid-containing material comprising the goethite particles to pre-freezing at a temperature of not more than 0° C., and gradually raising the temperature after completion of the freezing while maintaining a vacuum degree of not more than 100 Pa to dry the material in a temperature range of 0 to 80° C. until the water content therein is reduced to not more than 10%, or a method of reducing a vacuum degree of the liquid-containing material comprising the goethite particles until reaching not more than 100 Pa to thereby allow the material to be self-frozen, and gradually raising the temperature from the self-frozen condition to dry the material in a temperature range of 0 to 80° C. until the water content therein is reduced to not more than 10%.

The pre-freezing temperature of the liquid-containing material comprising the goethite particles is preferably not more than 0° C. and more preferably not more than −30° C. When the pre-freezing temperature is more than 0° C., the liquid constituting the liquid-containing material comprising the goethite particles may not be completely transformed into solids, so that it is not possible to remove the liquid by sublimation upon the vacuum drying, resulting in occurrence of aggregation between the goethite particles.

The vacuum drying condition is controlled such that the vacuum degree is preferably not more than 100 Pa, more preferably not more than 90 Pa and still more preferably not more than 80 Pa. The vacuum drying temperature is gradually raised in a temperature range of preferably 0 to 80° C. and more preferably 10 to 60° C.

In the present invention, the goethite particles obtained after subjected to the vacuum freeze drying have substantially the same particle size as that of the goethite particles before subjected to the vacuum freeze drying, and the average primary major axis diameter thereof is 5 to 250 nm. In addition, the goethite particles obtained after subjected to the vacuum freeze drying have a bulk density (ρa) of preferably not more than 0.28 g/cm³, more preferably not more than 0.27 g/cm³ and still more preferably not more than 0.26 g/cm³, and a ratio of (D50)_{3bar}/(D50)_{5bar} of not more than 1.30, preferably not more than 1.25 and more preferably not more than 1.20.

When the bulk density (ρa) and the ratio of (D50)_{3bar}/(D50)_{5bar} of the goethite particles obtained after subjected to the vacuum freeze drying are respectively out of the above specified ranges, strong agglomeration between the goethite particles tends to be caused. Therefore, in the case where such goethite particles are used as a starting material for the ferromagnetic metal particles, the resulting ferromagnetic metal particles also tend to suffer from strong agglomeration so that a kneading torque tends to be hardly applied to such particles upon production of a magnetic coating material, thereby failing to attain a good dispersibility of the particles in the magnetic coating material.

In the present invention, the goethite particles obtained after subjected to the vacuum freeze drying preferably have a cobalt content of 4 to 50 atom % in terms of Co based on whole Fe therein, an aluminum content of 4 to 50 atom % in terms of Al based on whole Fe therein, and a rare earth element content of 2 to 30 atom % in terms of rare earth element based on whole Fe therein.

Next, the goethite particles obtained after subjected to the vacuum freeze drying are subjected to heat dehydration treatment in a non-reducing atmosphere to obtain hematite particles.

The non-reducing atmosphere is preferably under a flow of at least one gas selected from air, oxygen gas and nitrogen gas. Further, the non-reducing atmosphere may also comprise water vapor, etc.

The heat dehydration may be conducted at a temperature of 100 to 650° C. When the heat dehydration temperature is less than 100° C., the heat dehydration treatment tends to require a prolonged time. When the heat dehydration temperature is more than 650° C., deformation of the particles and sintering within and between the particles tend to be undesirably caused. In addition, the heat dehydration treatment may be conducted by multi-stage treatment in which the temperatures in the first and second stages may be changed from each other.

Next, the hematite particles are subjected to heat reduction treatment.

In the present invention, the heat reduction treatment is preferably conducted at a temperature of 300 to 700° C. When the heat reduction temperature is less than 300° C., the reduction reaction tends to proceed too slowly and, therefore, require a prolonged time. Further, the crystal growth of the ferromagnetic metal particles tends to be insufficient, so that magnetic properties of the resulting particles such as saturation magnetization and coercive force tend to be considerably deteriorated. When the heat reduction temperature is more than 700° C., the reduction reaction tends to proceed too rapidly, so that deformation of the particles and sintering within and between the particles tend to be undesirably caused. In addition, the heat reduction treatment may be conducted by multi-stage treatment in which the temperatures in the first and second stages and, if required, the third or subsequent stages may be changed from each other.

Examples of the reducing gas used in the heat reduction treatment in the present invention include hydrogen gas, acetylene gas and carbon monoxide gas. Among these reducing gases, especially preferred is hydrogen gas.

The ferromagnetic metal particles obtained after the heat reduction in the present invention may be taken out in atmospheric air by subjecting the particles to surface oxidation treatment by known methods, for example, a method of immersing the particles in an organic solvent such as toluene, a method of once replacing an atmosphere around the ferromagnetic metal particles obtained after the heat reduction with an inert gas, and then gradually increasing an oxygen content in the inert gas to finally replace the inert gas with air, and a method of gradually oxidizing the particles using a mixed gas of oxygen and water vapor.

In the present invention, among these methods, there are preferably used the method of once replacing an atmosphere around the ferromagnetic metal particles obtained after the heat reduction with an inert gas, and then gradually increasing an oxygen content in the inert gas to finally replace the inert gas with air, and the method of gradually oxidizing the particles using a mixed gas of oxygen and water vapor. In this case, the temperature used in the surface oxidization treatment is 40 to 200° C. and preferably 40 to 180° C. When the surface oxidation treatment temperature is less than 40° C., it may be difficult to form a surface oxide layer having a sufficient thickness. When the surface oxidation treatment temperature is more than 200° C., The thickness of the surface oxide layer tends to be too large, resulting in deterioration of magnetic properties. In addition, the resulting particles tend to suffer from change in particle shape, in particular, tend to be extremely swelled in the minor axis direction owing to production of a large amount of oxide, which tends to result in destruction of shape of the particles in the worse case.

Next, the magnetic recording medium of the present invention is described.

The magnetic recording medium of the present invention comprises a non-magnetic substrate, a non-magnetic undercoat layer formed on the non-magnetic substrate, and a magnetic recording layer formed on the non-magnetic undercoat layer. In addition, a back coat layer may be formed on the surface of the non-magnetic substrate which is opposite to its surface on which the magnetic recording layer is disposed. In particular, back-up recording tapes used for computers are preferably provided with such a back coat layer from the viewpoints of preventing unevenness of winding or enhancing running durability.

In the present invention, as the non-magnetic substrate, there may be employed those substrates generally used at present for production of magnetic recording media. Examples of the non-magnetic substrate include films of synthetic resins, e.g., polyesters such as polyethylene terephthalate and polyethylene naphthalate, polyolefins such as polyethylene and polypropylene, polycarbonates, polyamides, polyamide imides, polyimides, aromatic polyamides, aromatic polyimides, aromatic polyamide imides, polysulfones, cellulose triacetate, polybenzoxazole, etc.; and foils and plates of metals such as aluminum and stainless steel; and various papers.

The non-magnetic undercoat layer used in the present invention comprises non-magnetic particles and a binder resin. If required, the non-magnetic undercoat layer may also comprise various additives usually used for production of magnetic recording media, such as lubricants, abrasives and antistatic agents.

Examples of the non-magnetic particles used in the non-magnetic undercoat layer include particles of alumina, hematite, goethite, titanium oxide, silica, chromium oxide, cerium oxide, zinc oxide, silicon nitride, boron nitride, silicon carbide, calcium carbonate and barium sulfate. These non-magnetic particles may be used alone or in combination of any two or more thereof. Among these non-magnetic particles, preferred are particles of hematite, goethite and titanium oxide, and more preferred are particles of hematite.

The non-magnetic particles may be of any shape including an acicular shape, a spindle shape, a rice grain-like shape, a spherical shape, a granular shape, a polyhedral shape, a flake-like shape, a scale-like shape and a plate shape. The particle size of the non-magnetic particles is preferably 0.005 to 0.30 μm and more preferably 0.010 to 0.25 μm. The surface of the respective non-magnetic particles may be coated, if required, with at least one compound selected from the group consisting of hydroxides of aluminum, oxides of aluminum, hydroxides of silicon and oxides of silicon. The thus coated non-magnetic particles can be improved in dispersibility in a non-magnetic coating material as compared to the uncoated non-magnetic particles.

As the binder resin, there may be employed those binder resins which are generally used for production of magnetic recording media. Examples of the binder resins include thermoplastic resins, thermosetting resins and electron beam-curable resins. These binder resins may be used alone or in combination of any two or more thereof.

Examples of the antistatic agents usable in the non-magnetic undercoat layer include conductive particles of carbon black, graphite, tin oxide, titanium oxide/tin oxide/antimony oxide, etc., and surfactants. In particular, as the antistatic agent, there is preferably used carbon black because it is expected to attain, in addition to the antistatic effect, the effects of reducing a friction coefficient and enhancing a strength of the resulting magnetic recording medium.

The magnetic recording layer in the magnetic recording medium of the present invention comprises the ferromagnetic metal particles of the present invention and a binder resin. The magnetic recording layer may also comprise, if required, various additives usually used for production of magnetic recording media, such as lubricants, abrasives and antistatic agents.

As the binder resin for the magnetic recording layer, there may be used the same binder resins as used for production of the above non-magnetic undercoat layer.

The back coat layer in the magnetic recording medium of the present invention preferably comprises, in addition to a binder resin, an antistatic agent and inorganic particles for the purposes of reducing a surface resistivity and a light transmittance of the magnetic recording medium and enhancing a strength thereof. Further, the back coat layer may also comprise, if required, various additives usually used for production of magnetic recording media, such as lubricants and abrasives.

The binder resin and antistatic agent used in the back coat layer may be the same as those used for producing the non-magnetic undercoat layer and the magnetic recording layer.

As the inorganic particles, there may be used one or more kinds of particles selected from the group consisting of particles of alumina, hematite, goethite, titanium oxide, silica, chromium oxide, cerium oxide, zinc oxide, silicon nitride, boron nitride, silicon carbide, calcium carbonate and barium sulfate. The particle size of the inorganic particles is preferably 0.005 to 1.0 μm and more preferably 0.010 to 0.5 μm.

The magnetic recording medium of the present invention preferably has a coercive force of 63.7 to 318.3 kA/m (800 to 4000 Oe) and more preferably 71.6 to 318.3 kA/m (900 to 4000 Oe), and a coercive force distribution SFD of not more than 0.80, more preferably not more than 0.75 and still more preferably not more than 0.70. The surface roughness Ra of coating film of the magnetic recording medium is preferably not more than 3.0 nm, more preferably not more than 2.8 nm and still more preferably not more than 2.6 nm. If the dispersion of ferromagnetic metal particles in the magnetic coating is insufficient, the surface roughness Ra of coating film of the magnetic recording medium tends to be increased.

Next, the process for producing the magnetic recording medium according to the present invention is described.

The non-magnetic undercoat layer, the magnetic recording layer and the back coat layer are formed as follows. The components constituting the respective layers together with a solvent therefor are kneaded and dispersed using ordinary kneader and disperser to prepare a coating material for the respective layers. The coating materials for the non-magnetic undercoat layer and the magnetic recording layer are successively applied in this order onto one surface of the non-magnetic substrate, dried and then subjected to calendar treatment. The coating of the respective coating materials may be conducted by either a wet-on-wet method in which the coating materials for the magnetic layer and the non-magnetic layer are applied substantially at the same time, or by a wet-on-dry method in which the coating material for the non-magnetic undercoat layer is first applied and dried, and then the coating material for the magnetic recording layer is applied on the resulting non-magnetic undercoat layer. The back coat layer, if provided, may be formed as follows. That is, the coating material for the back coat layer is applied on the surface of the non-magnetic substrate which is opposite to the surface where the non-magnetic undercoat layer and the magnetic recording layer are disposed, dried and then subjected to calendar treatment, thereby obtaining a magnetic recording medium.

Examples of the solvent used upon production of each of the non-magnetic undercoat layer, the magnetic recording layer and the back coat layer, include those generally used for production of magnetic recording media, e.g., ketones such as acetone, methyl ethyl ketone, methyl isobutyl ketone, cyclohexanone and tetrahydrofuran; aromatic hydrocarbons such as toluene and xylene; alcohols such as methanol, ethanol, propanol, butanol, isobutyl alcohol and isopropyl alcohol; esters such as methyl acetate, butyl acetate, isobutyl acetate and glycerol acetate; glycol ethers such as glycol dimethyl ether, glycol monoethyl ether and dioxane; and mixtures thereof.

### <Function>

The important feature of the present invention resides in such a point that the ferromagnetic metal particles produced by subjecting the liquid-containing material comprising the goethite particles to vacuum freeze drying, heat-treating the resulting freeze-dried goethite particles to obtain hematite particles and then subjecting the hematite particles to heat reduction at a temperature of 300 to 600° C., are excellent in dispersibility and exhibit a high filling rate in the magnetic recording layer, and further the magnetic recording medium produced by using the ferromagnetic metal particles has a high surface smoothness.

The reasons why the ferromagnetic metal particles of the present invention have an excellent dispersibility and a high filling rate in the magnetic recording layer, and why the magnetic recording medium produced by using the ferromagnetic metal particles exhibits a high surface smoothness, are considered by the present inventors as follows.

That is, since the liquid-containing material comprising the goethite particles is subjected to vacuum freeze drying, the liquid constituting the liquid-containing material which is kept in a solid state by the to vacuum freeze drying can be removed therefrom by sublimation. Therefore, as compared to the case where the liquid is evaporated by high-temperature heat treatment, the goethite particles can be prevented from suffering from agglomeration therebetween, so that sintering between the particles upon transforming the goethite particles into the hematite particles by subjecting the particles to high-temperature heat treatment and further upon transforming the hematite particles into the ferromagnetic metal particles, can be effectively inhibited. In addition, even the liquid trapped in hardly dryable portions such as concaved portions on the surface of the particles can be efficiently removed therefrom. As a result, the thus obtained ferromagnetic metal particles are bulky and can be deaggregated even when applying a very small dispersing force thereto, and are, therefore, excellent in dispersibility. Further, since the ferromagnetic metal particles are readily applied with a kneading torque upon production of a magnetic coating material, the filling rate of the ferromagnetic metal particles in the magnetic recording layer can be increased, so that the resulting magnetic recording medium can exhibit a high surface smoothness.

Thus, the ferromagnetic metal particles of the present invention can be deaggregated even when applying a very small dispersing force thereto and are, therefore, excellent in dispersibility, and further have a high filling rate in the magnetic recording layer since a kneading torque can be readily applied to the particles upon production of a magnetic coating material. Therefore, the ferromagnetic metal particles of the present invention are suitable as ferromagnetic metal particles for high-density magnetic recording media.

In addition, the magnetic recording medium of the present invention using the ferromagnetic metal particles of the present invention as magnetic particles can exhibit a high surface-smoothening effect when subjected to calendar treatment. Further, in the magnetic recording medium, it is expected that the ferromagnetic metal particles have a high filling rate in the magnetic recording layer. Therefore, the magnetic recording medium of the present invention is suitable as a high-density magnetic recording medium having an enhanced recording density.

### EXAMPLES

The present invention is described in more detail below by Examples and Comparative Examples.

The average primary major axis diameter and the average primary minor axis diameter of the particles were measured by the following procedure.

First, the particles were observed by a transmission electron microscope while adjusting a magnification thereof in a visual field where the individual particles were dispersed not in an overlapped state but in a divided state, and photographed. Next, major axis diameters and minor axis diameters of about 360 particles appearing on the micrograph enlarged by four times in each of longitudinal and lateral directions were measured using a “DIGITIZER” (Model: KD 4620; manufactured by Graphtec Co., Ltd.) to calculate an average primary major axis diameter and an average primary minor axis diameter of the particles, respectively, from the measured values.

The aspect ratio of the particles was expressed by a ratio of the average primary major axis diameter to the average primary minor axis diameter.

The specific surface area of the particles was expressed by the value measured by BET method.

The contents of Co, Al and Y present within the goethite particles and ferromagnetic metal particles or on the surface thereof, were measured by a “Fluorescent X-ray Analyzer 3063 M type” (manufactured by Rigaku Denki Kogyo Co., Ltd.) according to JIS K0119 “rGeneral rule of fluorescent X-ray analysis”.

The bulk density (pa) of each of the goethite particles and the ferromagnetic metal particles was measured using a “Powder Tester PT-N Model” manufactured by Hosokawa Micron Co., Ltd.

The tap density (ρt) of the ferromagnetic metal particles was measured according to JIS K5101.

The Hausner ratio of the ferromagnetic metal particles was determined as the ratio of tap density (ρt)/bulk density (ρa).

The compressed density (CD) of the ferromagnetic metal particles was expressed by the density thereof measured upon compressing the ferromagnetic metal particles under a pressure of 7.056 MPa.

The ratio of bulk density (ρa)/compressed density (CD) of the ferromagnetic metal particles was determined by dividing the value of the above bulk density (ρa) by the value of the above compressed density (CD).

The ratio of (D50)_{3bar}/(D50)_{5bar} of each of the goethite particles and the ferromagnetic metal particles was determined as follow. First, the sample particles were previously passed through a 60-mesh sieve (mesh size: 250 μm), and then the volume-average diameter of the respective particles under a dispersing pressure of 0.3 MPa (3 bar) as well as the volume-average diameter thereof under a dispersing pressure of 0.3 MPa (3 bar) were measured using a dry dispersion unit in a laser diffraction particle size measuring apparatus “Model HELOS LA/KA” manufactured by SYMPATEC Inc., to calculate the ratio of (D50)_{3bar}/(D50)_{5bar}.

The magnetic properties of the ferromagnetic metal particles and the magnetic recording medium were measured using a “Vibration Sample Magnetometer VSM-3S-15” (manufactured by Toei Kogyo Co., Ltd.) by applying an external magnetic field of 795.8 kA/m thereto.

The surface roughness Ra of coating film of the magnetic recording medium was determined by measuring a center line average roughness Ra of the coating film using “Surfcom-575A” manufactured by Tokyo Seimitsu Co., Ltd.

### Example 1-1

### Production of Ferromagnetic Metal Particles

A slurry of goethite particles 1 (particle shape: spindle shape; average primary major axis diameter: 51 nm; aspect ratio: 8.8; BET specific surface area: 243.5 m²/g; bulk density (ρa): 0.31 g/cm³; (D50)_{3bar}/(D50)_{5bar}: 1.37; Co content (Co/Fe): 40 atom %; Al content (Al/Fe): 20 atom %; Y content (Y/Fe): 20 atom %) was washed with water and filtered by ordinary methods to adjust a solid content therein to 31% by weight, and then treated with an extrusion molding machine, thereby obtaining a liquid-containing material comprising the goethite particles 1.

Next, the liquid-containing material comprising the goethite particles 1 were completely freeze-dried at −50° C. After completion of the freeze-drying, the vacuum degree was changed to 50 Pa, and while keeping the vacuum condition, the freeze-dried product was heated and dried while gradually raising the temperature from −50° C. as the free-drying temperature up to 50° C., thereby obtaining goethite particles 6. The water content in the obtained goethite particles 6 was 0.54%.

As a result, it was confirmed that the resulting goethite particles 6 had an average primary major axis diameter of 51 nm, an aspect ratio of 8.8, a BET specific surface area of 244.6 m²/g, a bulk density (ρa) of 0.22 g/cm³, a ratio of (D50)_{3bar}/(D50)_{5bar} of 1.11, a Co content (Co/Fe) of 40 atom %, an Al content (Al/Fe) of 20 atom %, and Y content (Y/Fe) of 20 atom %.

### <Heat Dehydration Treatment>

The above obtained goethite particles 6 were dehydrated at 350° C. in atmospheric air and then heat-dehydrated at 500° C. in the same atmosphere to obtain hematite particles.

### <Heat Reduction Treatment>

The thus obtained hematite particles in an amount of 100 g were charged into a batch-type fixed bed reducing apparatus having an inner diameter of 72 mm. Then, after adjusting a height of the fixed bed to 7 cm, the hematite particles were subjected to heat reduction at 350° C. until the dew point of a gas discharged from the apparatus reached −30° C. while flowing a hydrogen gas therethrough at a superficial velocity of 50 cm/s, thereby obtaining ferromagnetic metal particles.

Then, after replacing the hydrogen gas with a nitrogen gas again, the obtained particles were cooled to 80° C. and maintained at that temperature. Successively, air was mixed with the nitrogen gas, and the amount of air mixed was gradually increased until the oxygen concentration of the mixed gas reached 0.35 vol %. Under such an atmosphere, the particles were subjected to surface oxidation treatment until the temperature thereof reached the “retention temperature plus 1° C.” (maximum temperature of particles: 140° C.; treating time: 2 hr), thereby forming a surface oxide layer on the surface of the respective particles.

Next, the resulting ferromagnetic metal particles on which the surface oxide layer was formed, were heated to 600° C. taking 10 minutes in a hydrogen gas atmosphere, and subjected to heat reduction again at 600° C. while passing a hydrogen gas therethrough at a superficial velocity of 60 cm/s until the dew point of a gas discharged from the apparatus reached −30° C.

Thereafter, the hydrogen gas was replaced with a nitrogen gas again, and the obtained particles were cooled to 80° C. and maintained at that temperature. Successively, 6 g/m³ of water vapor and air were mixed with the nitrogen gas, and the amount of air mixed was gradually increased until the oxygen concentration of the mixed gas reached 0.35 vol %. Under such an atmosphere, the particles were subjected to surface oxidation treatment until the temperature thereof reached the “retention temperature plus 1° C.” (maximum temperature of particles: 110° C.; treating time: 3 hr), thereby forming a stable surface oxide layer on the surface of the respective particles and producing ferromagnetic metal particles of Example 1-1.

It was confirmed that the thus obtained ferromagnetic metal particles were spindle-shaped particles having an average primary major axis diameter of 39 nm, an aspect ratio of 3.6, a BET specific surface area of 85.4 m²/g, a bulk density (ρa) of 0.196 g/cm³, a tap density (ρt) of 0.309 g/cm³, a Husner ratio of 1.58, a compressed density (CD) of 1.26 g/cm³, a ratio of bulk density (ρa)/compressed density (CD) of 0.16, and a ratio of (D50)_{3bar}/(D50)_{5bar} of 1.10. Also, it was confirmed that the ferromagnetic metal particles of Example 1-1 had a Co content of 40 atom % based on whole Fe, an Al content of 18 atom % based on whole Fe, and a Y content of 20 atom % based on whole Fe. As to the magnetic properties of the ferromagnetic metal particles, the coercive force Hc thereof was 195.0 kA/m, and the saturation magnetization as thereof was 104.5 Am²/kg.

### Example 2-1

### Production of Magnetic Recording Medium

Twelve grams of hematite particles were mixed with a binder resin solution (comprising 30% by weight of a vinyl chloride-based copolymer resin having a potassium sulfonate group, and 70% by weight of cyclohexanone) and cyclohexanone. The resultant mixture was kneaded for 30 min using an automatic mortar, thereby obtaining a kneaded material.

The obtained kneaded material was charged, together with 95 g of 1.5 mmφ glass beads, an additional amount of a binder resin solution (comprising 30% by weight of a polyurethane resin having a sodium sulfonate group, and 70% by weight of a mixed solvent comprising methyl ethyl ketone and toluene at a mixing ratio of 1:1), cyclohexanone, methyl ethyl ketone and toluene, into a 140-mL glass bottle. The resultant mixture was mixed and dispersed for 6 hr using a paint shaker, thereby obtaining a coating composition. Thereafter, the obtained coating composition was mixed with a lubricant and a curing agent, and the resultant mixture was further mixed and dispersed for 15 min using a paint shaker. Thereafter, the obtained mixture was filtered through a filter having an average pore size of 3 μm, thereby producing a non-magnetic coating material for non-magnetic undercoat layer.

The thus obtained non-magnetic coating material for non-magnetic undercoat layer had the following composition.

| | | |
|---|---|---|
| Hematite particles for non-magnetic | 100.0 | parts by weight |
| undercoat layer (particle shape: | | |
| spindle shape; average primary major | | |
| axis diameter: 0.099 μm; aspect | | |
| ratio: 6.2; BET specific surface | | |
| area: 59.1 m²/g) | | |
| Vinyl chloride-based copolymer resin | 11.8 | parts by weight |
| having a potassium sulfonate group | | |
| Polyurethane resin having a sodium | 11.8 | parts by weight |
| sulfonate group | | |
| Cyclohexanone | 78.3 | parts by weight |
| Methyl ethyl ketone | 195.8 | parts by weight |
| Toluene | 117.5 | parts by weight |
| Curing agent (polyisocyanate) | 3.0 | parts by weight |
| Lubricant (butyl stearate) | 1.0 | part by weight |

Eighty grams of ferromagnetic metal particles, 8.0 g of an abrasive “AKP-50” (tradename) produced by Sumitomo Chemical Co., Ltd., and 0.8 g of carbon black were mixed with a binder resin solution (comprising 30% by weight of a vinyl chloride-based copolymer resin having a potassium sulfonate group, and 70% by weight of cyclohexanone) and cyclohexanone to prepare a mixture (having a solid content of 70.8%). The resulting mixture was kneaded using a kneader “LABO PLASTOMILL” (manufactured by Toyo Seiki Seisakusho Co., Ltd.) for 60 min, and then methyl ethyl ketone was added to the mixture to adjust a solid content thereof to 60%, and the obtained mixture was further kneaded for 30 min.

The resulting kneaded material was sampled in an amount of 115 g, and mixed with methyl ethyl ketone and cyclohexanone to adjust a solid content thereof to 30%. The obtained mixture was dispersed using a “DISPER MAT” (manufactured by VMA-GETZMANN Inc.) for 60 min.

The obtained dispersion in an amount of 29.9 g was charged, together with 105 g of 0.5 mmφ glass beads, an additional amount of a binder resin solution (comprising 30% by weight of a polyurethane resin having a sodium sulfonate group, and 70% by weight of a mixed solvent comprising methyl ethyl ketone and toluene at a mixing ratio of 1:1), cyclohexanone, methyl ethyl ketone and toluene, into a 140-mL glass bottle. The resultant mixture was mixed and dispersed for 12 hr using a paint shaker to prepare a magnetic coating material. The obtained magnetic coating material was mixed with a lubricant and a curing agent. The resulting mixture was further mixed and dispersed for 15 min using a paint shaker, and then filtered through a filter having an average pore size of 3 μm, thereby producing a magnetic coating material for magnetic recording layer.

The obtained magnetic coating material for magnetic recording layer had the following composition.

| | | |
|---|---|---|
| Ferromagnetic metal particles | 100.0 | parts by weight |
| Vinyl chloride-based copolymer resin | 10.0 | parts by weight |
| having a potassium sulfonate group | | |
| Polyurethane resin having a sodium | 10.0 | parts by weight |
| sulfonate group | | |
| Abrasive (AKP-50) | 10.0 | parts by weight |
| Carbon black | 1.0 | part by weight |
| Lubricant (myristic acid:butyl stearate = 1:2) | 3.0 | parts by weight |
| Curing agent (polyisocyanate) | 5.0 | parts by weight |
| Cyclohexanone | 65.8 | parts by weight |
| Methyl ethyl ketone | 164.5 | parts by weight |
| Toluene | 98.7 | parts by weight |

The thus prepared coating material for non-magnetic undercoat layer was applied on 4.5 μm-thick aromatic polyamide film, and then dried to form a non-magnetic undercoat layer on the film. Then, the coating material for magnetic recording layer was applied onto the thus formed non-magnetic undercoat layer, and oriented and dried in a magnetic field to form a magnetic recording layer thereon. Next, the resulting layered product was subjected to calendar treatment and then to curing reaction at 60° C. for 24 hr, and slit into a width of 12.7 mm, thereby obtaining a magnetic recording medium.

As a result, it was confirmed that the resulting magnetic recording medium had a coercive force of 210.3 kA/m, a squareness (Br/Bm) of 0.853, a coercive force distribution SFD of 0.60 and a surface roughness Ra of 2.0 nm.

According to the procedures of Examples 1-1 and 2-1, the ferromagnetic metal particles and the magnetic recording medium were produced. The respective production conditions as well as various properties of the obtained ferromagnetic metal particles and magnetic recording medium are shown in Tables below.

### Goethite Particles 2 to 5:

Goethite particles 2 to 5 having properties as shown in Table 1 were prepared as starting materials.

TABLE 1

| Kinds of | Properties of goethite particles before subjected | | | | |
|---|---|---|---|---|---|
| goethite | to vacuum freeze drying | | | | |
| particles | | Average | | | |
| before | | primary | | BET | |
| subjected to | | major | | specific | Bulk |
| vacuum | | axis | Aspect | surface | density |
| freeze | Particle | diameter | ratio | area | (ρa) |
| drying | shape | (nm) | (−) | (m²/g) | (g/cm³) |
| Goethite | Spindle- | 51 | 8.8 | 243.5 | 0.31 |
| particles 1 | shaped | | | | |
| Goethite | Spindle- | 62 | 6.1 | 193.2 | 0.32 |
| particles 2 | shaped | | | | |
| Goethite | Spindle- | 78 | 9.3 | 179.3 | 0.33 |
| particles 3 | shaped | | | | |
| Goethite | Spindle- | 38 | 7.7 | 265.8 | 0.31 |
| particles 4 | shaped | | | | |
| Goethite | Spindle- | 130 | 7.6 | 145.4 | 0.34 |
| particles 5 | shaped | | | | |

| Kinds of | | | | | |
|---|---|---|---|---|---|
| goethite | Properties of goethite particles before subjected to | | | | |
| particles | vacuum freeze drying | | | | |
| before | | Content of respective elements | | | |
| subjected to | | | | Rare earth | |
| vacuum | (D50)_{3bar}/ | Co | Al | element | |
| freeze | (D50)_{5bar} | content | content | | Content |
| drying | (−) | (atom %) | (atom %) | Kind | (atom %) |
| Goethite | 1.37 | 40 | 20 | Y | 20 |
| particles 1 | | | | | |
| Goethite | 1.49 | 38 | 16 | Y | 22 |
| particles 2 | | | | | |
| Goethite | 1.51 | 35 | 8 | Y | 20 |
| particles 3 | | | | | |
| Goethite | 1.42 | 40 | 18 | Y | 25 |
| particles 4 | | | | | |
| Goethite | 1.55 | 30 | 4 | Y | 16 |
| particles 5 | | | | | |

### Goethite Particles 6 to 10:

The same procedure as defined in Example 1-1 was conducted except that kinds of goethite particles as starting material, solid content upon vacuum freeze drying treatment, pre-freezing temperature, vacuum degree and drying temperature were changed variously, thereby obtaining goethite particles after subjected to the vacuum freeze drying.

The production conditions are shown in Table 2, and various properties of the goethite particles obtained after subjected to the vacuum freeze drying are shown in Table 3.

### Goethite Particles 11:

The water-containing material in the form of granules comprising the goethite particles 1 was produced in the same way as defined in Example 1-1.

Next, the vacuum degree of the obtained water-containing material comprising the goethite particles 1 was changed to 50 Pa and self-frozen. The self-frozen product was gradually heated from the frozen state to 50° C. for drying, thereby obtaining goethite particles 11. The water content of the thus obtained goethite particles 11 was 1.27%.

Various properties of the obtained goethite particles 11 are shown in Table 3.

TABLE 2

| | Vacuum freeze drying treatment | | | | |
|---|---|---|---|---|---|
| | | | Pre- | | |
| | Kind of | Solid | freezing | Vacuum | Drying |
| Goethite | goethite | content | temperature | degree | temperature |
| particles | particles | (wt %) | (° C.) | (Pa) | (° C.) |
| Goethite | Goethite | 31 | −50 | 50 | 50 |
| particles 6 | particles 1 | | | | |
| Goethite | Goethite | 32 | −40 | 60 | 60 |
| particles 7 | particles 2 | | | | |
| Goethite | Goethite | 34 | −45 | 30 | 30 |
| particles 8 | particles 3 | | | | |
| Goethite | Goethite | 29 | −35 | 80 | 45 |
| particles 9 | particles 4 | | | | |
| Goethite | Goethite | 36 | −50 | 50 | 50 |
| particles | particles 5 | | | | |
| 10 | | | | | |

TABLE 3

| Kinds of | Properties of goethite particles after subjected to | | | | |
|---|---|---|---|---|---|
| goethite | vacuum freeze drying | | | | |
| particles | | Average | | | |
| after | | primary | | BET | |
| subjected to | | major | | specific | Bulk |
| vacuum | | axis | Aspect | surface | density |
| freeze | Particle | diameter | ratio | area | (ρa) |
| drying | shape | (nm) | (−) | (m²/g) | (g/cm³) |
| Goethite | Spindle- | 51 | 8.8 | 244.6 | 0.22 |
| particles 6 | shaped | | | | |
| Goethite | Spindle- | 62 | 6.1 | 194.8 | 0.23 |
| particles 7 | shaped | | | | |
| Goethite | Spindle- | 77 | 9.3 | 180.5 | 0.24 |
| particles 8 | shaped | | | | |
| Goethite | Spindle- | 38 | 7.7 | 266.7 | 0.21 |
| particles 9 | shaped | | | | |
| Goethite | Spindle- | 129 | 7.6 | 146.0 | 0.25 |
| particles 10 | shaped | | | | |
| Goethite | Spindle- | 51 | 8.8 | 246.1 | 0.20 |
| particles 11 | shaped | | | | |

| Kinds of | | | | | |
|---|---|---|---|---|---|
| goethite | Properties of goethite particles after subjected to | | | | |
| particles | vacuum freeze drying | | | | |
| after | | Content of respective elements | | | |
| subjected to | | | | Rare earth | |
| vacuum | (D50)_{3bar}/ | Co | Al | element | |
| freeze | (D50)_{5bar} | content | content | | Content |
| drying | (−) | (atom %) | (atom %) | Kind | (atom %) |
| Goethite | 1.11 | 40 | 20 | Y | 20 |
| particles 6 | | | | | |
| Goethite | 1.10 | 38 | 16 | Y | 22 |
| particles 7 | | | | | |
| Goethite | 1.13 | 35 | 8 | Y | 20 |
| particles 8 | | | | | |
| Goethite | 1.12 | 40 | 18 | Y | 25 |
| particles 9 | | | | | |
| Goethite | 1.17 | 30 | 4 | Y | 16 |
| particles 10 | | | | | |
| Goethite | 1.10 | 40 | 20 | Y | 20 |
| particles 11 | | | | | |

### Examples 1-2 to 1-6 and Comparative Examples 1-1 to 1-5

The same procedure as defined in Example 1-1 was conducted except that kinds of goethite particles were changed variously, thereby obtaining ferromagnetic metal particles.

The production conditions and various properties of the obtained ferromagnetic metal particles are shown in Table 4.

TABLE 4

| | | Properties of ferromagnetic metal | | |
|---|---|---|---|---|
| | | particles | | |
| | | | Average | |
| | | | primary | |
| Examples and | Kind of | | major axis | Aspect |
| Comparative | starting | Particle | diameter | ratio |
| Examples | material | shape | (nm) | (-) |
| Example 1-1 | Goethite | Spindle-shaped | 39 | 3.6 |
| | particles 6 | | | |
| Example 1-2 | Goethite | Spindle-shaped | 48 | 4.5 |
| | particles 7 | | | |
| Example 1-3 | Goethite | Spindle-shaped | 62 | 5.7 |
| | particles 8 | | | |
| Example 1-4 | Goethite | Spindle-shaped | 31 | 2.9 |
| | particles 9 | | | |
| Example 1-5 | Goethite | Spindle-shaped | 105 | 6.2 |
| | particles 10 | | | |
| Example 1-6 | Goethite | Spindle-shaped | 38 | 3.6 |
| | particles 11 | | | |
| Comparative | Goethite | Spindle-shaped | 41 | 3.7 |
| Example 1-1 | particles 1 | | | |
| Comparative | Goethite | Spindle-shaped | 50 | 4.5 |
| Example 1-2 | particles 2 | | | |
| Comparative | Goethite | Spindle-shaped | 64 | 5.8 |
| Example 1-3 | particles 3 | | | |
| Comparative | Goethite | Spindle-shaped | 33 | 3.0 |
| Example 1-4 | particles 4 | | | |
| Comparative | Goethite | Spindle-shaped | 107 | 6.3 |
| Example 1-5 | particles 5 | | | |

| | Properties of ferromagnetic metal particles | | | |
|---|---|---|---|---|
| | BET | | | |
| Examples and | specific | | | |
| Comparative | surface area | Bulk density | Tap density | Hausner |
| Examples | (m²/g) | (ρa) (g/cm³) | (ρt) (g/cm³) | ratio (-) |
| Example 1-1 | 85.4 | 0.196 | 0.309 | 1.58 |
| Example 1-2 | 76.9 | 0.204 | 0.316 | 1.55 |
| Example 1-3 | 71.4 | 0.215 | 0.320 | 1.49 |
| Example 1-4 | 90.2 | 0.198 | 0.311 | 1.57 |
| Example 1-5 | 41.8 | 0.221 | 0.325 | 1.47 |
| Example 1-6 | 85.7 | 0.193 | 0.307 | 1.59 |
| Comparative | 81.2 | 0.252 | 0.329 | 1.31 |
| Example 1-1 | | | | |
| Comparative | 75.1 | 0.259 | 0.334 | 1.29 |
| Example 1-2 | | | | |
| Comparative | 70.3 | 0.262 | 0.340 | 1.30 |
| Example 1-3 | | | | |
| Comparative | 89.0 | 0.255 | 0.327 | 1.28 |
| Example 1-4 | | | | |
| Comparative | 40.5 | 0.270 | 0.343 | 1.27 |
| Example 1-5 | | | | |

| | Properties of ferromagnetic metal particles | | | |
|---|---|---|---|---|
| | | Bulk density/ | | |
| | | compressed | | |
| Examples and | Compressed | density | | |
| Comparative | density | (ρa)/(CD) | (D50)_{3bar}/ | Co content |
| Examples | (CD) (g/cm³) | (-) | (D50)_{5bar} (-) | (atom %) |
| Example 1-1 | 1.26 | 0.16 | 1.10 | 40 |
| Example 1-2 | 1.35 | 0.15 | 1.09 | 38 |
| Example 1-3 | 1.43 | 0.15 | 1.13 | 35 |
| Example 1-4 | 1.18 | 0.17 | 1.12 | 40 |
| Example 1-5 | 1.82 | 0.12 | 1.18 | 30 |
| Example 1-6 | 1.26 | 0.15 | 1.09 | 40 |
| Comparative | 1.23 | 0.20 | 1.35 | 40 |
| Example 1-1 | | | | |
| Comparative | 1.30 | 0.20 | 1.34 | 38 |
| Example 1-2 | | | | |
| Comparative | 1.39 | 0.19 | 1.38 | 35 |
| Example 1-3 | | | | |
| Comparative | 1.04 | 0.25 | 1.40 | 40 |
| Example 1-4 | | | | |
| Comparative | 1.79 | 0.15 | 1.41 | 30 |
| Example 1-5 | | | | |

| | Properties of ferromagnetic metal particles | | | |
|---|---|---|---|---|
| Examples and | | | Coercive | Saturation |
| Comparative | Al content | Y content | force Hc | magnetization |
| Examples | (atom %) | (atom %) | (kA/m) | σs (Am²/kg) |
| Example 1-1 | 18 | 20 | 195.0 | 104.5 |
| Example 1-2 | 15 | 22 | 187.2 | 106.3 |
| Example 1-3 | 8 | 20 | 191.6 | 110.1 |
| Example 1-4 | 17 | 25 | 177.5 | 99.6 |
| Example 1-5 | 4 | 16 | 150.4 | 148.2 |
| Example 1-6 | 19 | 20 | 194.9 | 104.4 |
| Comparative | 19 | 20 | 194.2 | 104.8 |
| Example 1-1 | | | | |
| Comparative | 15 | 22 | 186.1 | 106.0 |
| Example 1-2 | | | | |
| Comparative | 8 | 20 | 189.9 | 110.4 |
| Example 1-3 | | | | |
| Comparative | 17 | 25 | 175.1 | 98.7 |
| Example 1-4 | | | | |
| Comparative | 4 | 16 | 149.2 | 148.9 |
| Example 1-5 | | | | |

### <Production of Magnetic Recording Medium>

### Examples 2-2 to 2-6 and Comparative Examples 2-1 to 2-5

The same procedure as defined in Example 2-1 was conducted except that kinds of ferromagnetic metal particles were changed variously, thereby producing magnetic recording media.

The production conditions and various properties of the obtained magnetic recording media are shown in Table 5.

TABLE 5

| | Properties of magnetic recording medium | | | | |
|---|---|---|---|---|---|
| Examples and | Coercive force | | | | Surface |
| Comparative | Hc | | Squareness | | roughness |
| Examples | kA/m | Oe | (−) | SFD (−) | Ra (nm) |
| Example 2-1 | 210.3 | 2642 | 0.853 | 0.60 | 2.0 |
| Example 2-2 | 200.4 | 2518 | 0.848 | 0.57 | 2.3 |
| Example 2-3 | 206.7 | 2598 | 0.844 | 0.54 | 2.3 |
| Example 2-4 | 193.6 | 2433 | 0.794 | 0.68 | 2.1 |
| Example 2-5 | 165.1 | 2075 | 0.851 | 0.49 | 2.7 |
| Example 2-6 | 210.2 | 2642 | 0.853 | 0.59 | 2.0 |
| Comparative | 208.8 | 2634 | 0.839 | 0.78 | 3.4 |
| Example 2-1 | | | | | |
| Comparative | 198.7 | 2507 | 0.832 | 0.75 | 3.5 |
| Example 2-2 | | | | | |
| Comparative | 204.6 | 2571 | 0.827 | 0.73 | 3.7 |
| Example 2-3 | | | | | |
| Comparative | 189.9 | 2386 | 0.785 | 0.83 | 3.6 |
| Example 2-4 | | | | | |
| Comparative | 163.9 | 2059 | 0.846 | 0.70 | 3.9 |
| Example 2-5 | | | | | |

From Table 5, it was apparently confirmed that in Examples to 2-6 according to the present invention, the surface roughness Ra was not more than 3.0 nm, the resulting magnetic recording media were excellent in various properties. On the other hand, in Comparative Examples 2-1 to 2-5 out of the scope of the present invention, the surface roughness Ra was more than 3.0 nm. Therefore, it was confirmed that the magnetic recording media obtained in these Comparative Examples were deteriorated in various properties.

Thus, the ferromagnetic metal particles according to the present invention are readily deaggregated even when applying a very small dispersing force thereto and, therefore, excellent in dispersibility. Further, the ferromagnetic metal particles are easily applied with a kneading torque upon production of a magnetic coating material and, therefore, exhibit a high filling rate in a magnetic recording layer. Therefore, the ferromagnetic metal particles of the present invention are suitable as ferromagnetic metal particles for high-density magnetic recording media.

Further, the magnetic recording medium according to the present invention using the above ferromagnetic metal particles of the present invention as magnetic particles exhibits a high surface-smoothening effect when subjected to calendar treatment. In addition, since it is expected that the ferromagnetic metal particles are dispersed in the magnetic recording layer with a high filling rate, the resulting magnetic recording medium is suitable as high-density magnetic recording media having an enhanced recording density.

What is claimed is:

1. Ferromagnetic metal particles having a bulk density (ρa) of not more than 0.25 g/cm³.

2. Ferromagnetic metal particles according to claim 1, which have a tap density (ρt) of not more than 0.39 g/cm³.

3. Ferromagnetic metal particles according to claim 1, which have a Hausner ratio of the tap density (ρt) to the bulk density (ρa) (ρt/ρa) of not more than 1.80.

4. Ferromagnetic metal particles according to claim 1, comprising Fe, Co, Al and rare earth element.

5. Ferromagnetic metal particles according to claim 1, which have a coercive force Hc of 79.6 to 278.5 kA/m.

6. Ferromagnetic metal particles according to claim 1, which have a saturation magnetization (σs) of 50 to 180 Am²/kg.

7. Ferromagnetic metal particles according to claim 1, which have a ratio of a volume-average diameter (D50)_{3bar} under a dispersing pressure of 3 bar to a volume-average diameter (D50)_{5bar} under a dispersing pressure of 5 bar ((D50)_{3bar}/(D50)_{5bar}) of not more than 1.2.

8. A process for producing the ferromagnetic metal particles as defined in claim 1, comprising the steps of:
subjecting a liquid-containing material comprising goethite particles and having a solid content of not more than 50% by weight to vacuum freeze drying;
subjecting the freeze-dried goethite particles to heat dehydration to obtain hematite particles; and
subjecting the hematite particles to heat reduction to obtain magnetic metal particles.

9. A magnetic recording medium comprising a non-magnetic substrate; a non-magnetic undercoat layer formed on the non-magnetic substrate which comprises non-magnetic particles and a binder resin; and a magnetic recording layer formed on the non-magnetic undercoat layer which comprises magnetic particles and a binder resin, wherein the ferromagnetic metal particles as defined in claim 1 were used as the magnetic particles.
